(19) United States
(12) Patent Application Publication
(10) Pub. No.: US 2026/0075050 A1
(43) Pub. Date: Mar. 12, 2026

(54) Custom Endpoint Creation For Cloud Application Instance

(71) Applicant: Oracle International Corporation, Redwood Shores, CA (US)

(72) Inventors: Jagrut R. Desai, Shrewsbury, MA (US); Philip Varghese, Mountain House, CA (US); Mohamed Aariff, Santa Clara, CA (US); Arun Kumar Bathini, Hyderabad (IN)

(73) Assignee: Oracle International Corporation, Redwood Shores, CA (US)

(21) Appl. No.: 18/916,255

(22) Filed: Oct. 15, 2024

Related U.S. Application Data
(60) Provisional application No. 63/691,714, filed on Sep. 6, 2024.

(51) Int. Cl. H04L 9/40

(52) U.S. Cl. CPC H04L 63/0823; H04L 63/166

(57) ABSTRACT

Techniques for creating a custom endpoint for a cloud application instance are disclosed. In some embodiments, a system receives a user request to enable a custom endpoint to be used to access a cloud application instance. In response to the user request, the system validates the custom endpoint in a Domain Name System (DNS) zone of a customer tenancy of a cloud platform in which the cloud application instance is hosted, obtains a security token of the cloud application instance from the customer tenancy, creates a DNS record in the DNS zone using the security token, obtains a digital certificate for the custom endpoint using the DNS record, and creates an association between the digital certificate and the custom endpoint on the cloud platform, wherein the association between the digital certificate and the custom endpoint enables access to the cloud application instance via the custom endpoint.

### CROSS-REFERENCE TO RELATED APPLICATIONS

This application claims the benefit of U.S. Provisional Patent Application No. 63/691,714, filed Sep. 6, 2024, and entitled “Custom Endpoint Creation For Cloud Application Instance,” which is incorporated herein by reference in its entirety as if set forth herein.

### TECHNICAL FIELD

The present disclosure relates to endpoints for accessing cloud applications. In particular, the present disclosure relates to creating a custom endpoint for an instance of a cloud application.

### BACKGROUND

Cloud applications are software programs that are hosted and run on cloud infrastructure. A cloud infrastructure may use remote servers for processing logic that is accessed through a web browser with a continual internet connection. Users may interact with a cloud application via a client interface, such as a web browser or mobile device app, while the cloud application's compute cycles and data is stored in a remote data center typically operated by a third-party company, such as a cloud service provider.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in which a cloud platform architecture is implemented in accordance with one or more embodiments;

FIG. 7 illustrates an example set of operations for creating a custom endpoint for a cloud application instance in accordance with one or more embodiments;

FIG. 8 illustrates an example set of operations for renewing a digital certificate for a custom endpoint for a cloud application instance in accordance with one or more embodiments; and

FIG. 9 illustrates an example embodiment of a cloud platform using a custom endpoint that has been created for a cloud application instance.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. CLOUD PLATFORM ARCHITECTURE
5. CREATING CUSTOM ENDPOINT FOR CLOUD APPLICATION INSTANCE
6. EXAMPLE EMBODIMENTS
7. MISCELLANEOUS; EXTENSIONS

### 1. GENERAL OVERVIEW

The present disclosure describes techniques for automating the process of creating a custom endpoint of a cloud application instance by efficiently, accurately, and effectively procuring a digital certificate for the custom endpoint and integrating the digital certificate with a network infrastructure. The present disclosure also describes techniques for automatically renewing the digital certificate for the custom endpoint. These techniques completely eliminate the manual and error prone process that results in outages and issue escalations.

When a customer creates a cloud compute instance of a cloud application on a cloud platform, a cloud service provider may provide an original endpoint (e.g., a domain name). However, many customers may want to use their own custom endpoint (e.g., a vanity domain name) and not the endpoint of the cloud service provider. In order to enable the use of the customer's custom endpoint, the customer has to acquire a digital certificate and upload it to the cloud service provider infrastructure, and the cloud service provider infrastructure needs to import this digital certificate to the cloud service provider load balancer. This process creates technical issues, as digital certificates acquired and uploaded by users may not be in a valid format or the certificate authority (CA) that issued the digital certificate acquired and uploaded by the user may not be supported by the cloud platform. As a result of these technical issues, production downtime may occur. Furthermore, when a digital certificate is about to expire, there is no way to notify the customer, resulting in production outages. These technical also result in the creation and processing of internal security issue tickets, such as via the use of an information technology (IT) ticketing system, and the cloud service provider has to follow up with customers.

The present disclosure describes techniques for automatically creating a custom endpoint of a cloud application instance by procuring a digital certificate and associating the digital certificate with the custom endpoint within the cloud platform hosting the cloud application instance. As a result of the techniques disclosed herein, users of the cloud application instance may use the custom endpoint to access the cloud application instance.

One or more embodiments receive a user request to enable a custom endpoint to be used to access a cloud application instance, and then, responsive to the user request, automatically execute a custom endpoint creation process. The user request may specify the custom endpoint. The cloud application instance may be hosted in a customer tenancy of a cloud platform. The cloud application instance may be accessible via an original endpoint that is mapped to the cloud application instance. In some embodiments, the custom endpoint creation process comprises: validating the custom endpoint in a Domain Name System (DNS) zone of the customer tenancy; obtaining a security token of the cloud application instance from the customer tenancy; creating a DNS record in the DNS zone of the customer tenancy using the security token, wherein the DNS record maps the custom endpoint to the cloud application instance; obtaining a first digital certificate for the custom endpoint using the DNS record; and creating an association between the first digital certificate and the custom endpoint on the cloud platform. The association between the first digital certificate and the custom endpoint enables access to the cloud application instance via the custom endpoint.

In an embodiment, the creating the association between the first digital certificate and the custom endpoint comprises: creating a listener for the custom endpoint in a load balancer on the cloud platform, and then attaching the first digital certificate to the listener for the custom endpoint.

One or more embodiments receive, from a first computing device, a first HyperText Transfer Protocol Secure (HTTPS) request comprising the custom endpoint, and then allow the first computing device to access the cloud application instance using the custom endpoint based on the association between the first digital certificate and the custom endpoint. Additionally, one or more embodiments receive, from a second computing device, a second HTTPS request comprising the original endpoint, and then allow the second computing device to access the cloud application instance using the custom endpoint based on the original endpoint being mapped to the cloud application instance.

One or more embodiments determine a first expiration date of the first digital certificate, and then, at a point in time prior to the first expiration date of the first digital certificate, automatically execute a digital certificate renewal process. In some embodiments, the digital certificate renewal process comprises obtaining a second digital certificate for the custom endpoint using the DNS record, wherein the second digital certificate has a second expiration date that is after the first digital certificate, and then creating an association between the second digital certificate and the custom endpoint on the cloud platform, wherein the association between the second digital certificate and the custom endpoint enables access to the cloud application instance via the custom endpoint.

One or more embodiments described in this Specification and/or recited in the claims may not be included in this General Overview section.

### 2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

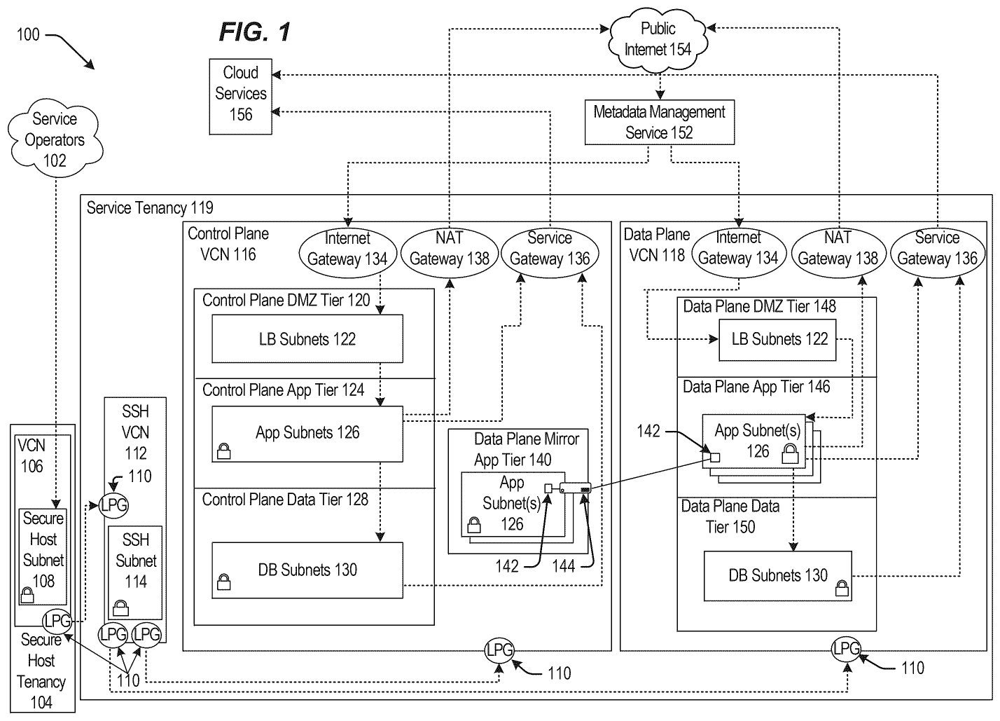

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

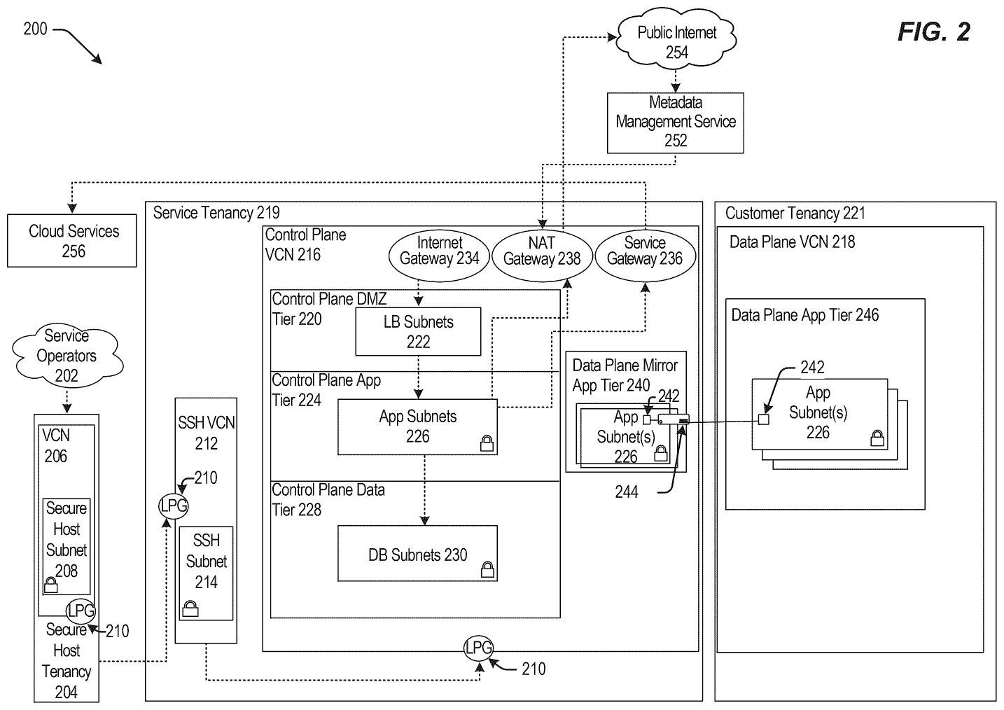

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

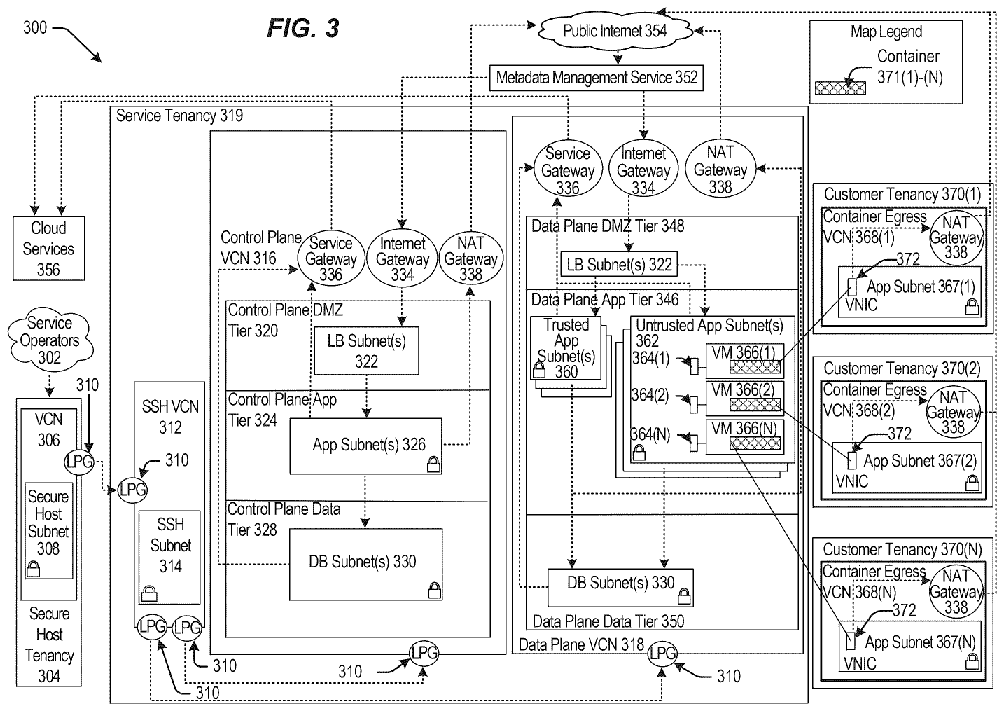

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

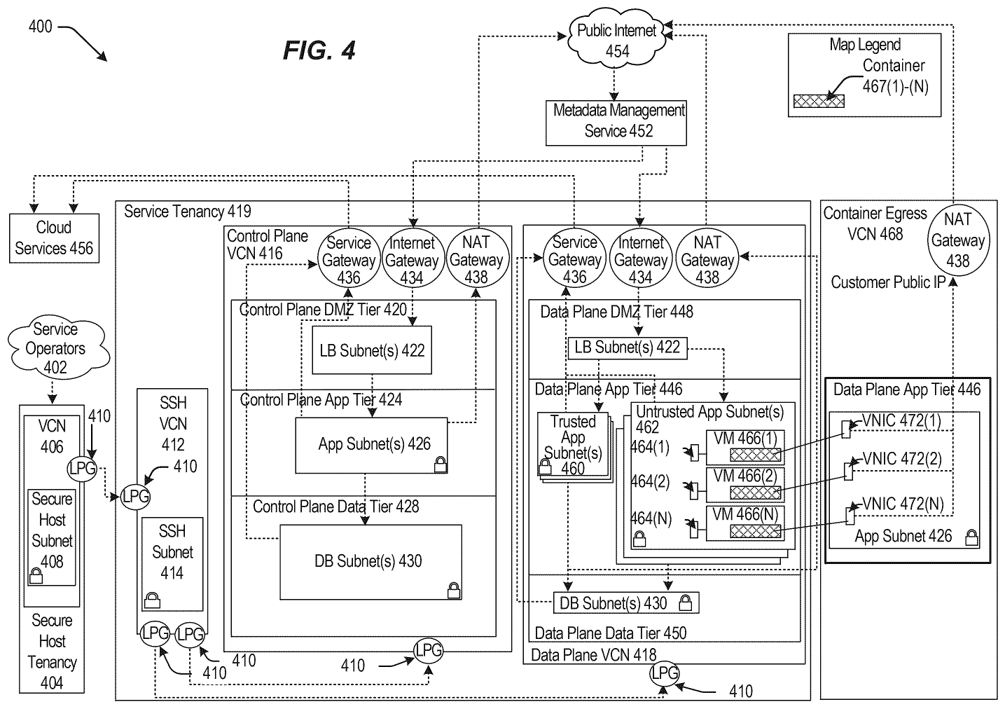

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP) or Hypertext Transfer Protocol Secure (HTTPS). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. COMPUTER SYSTEM

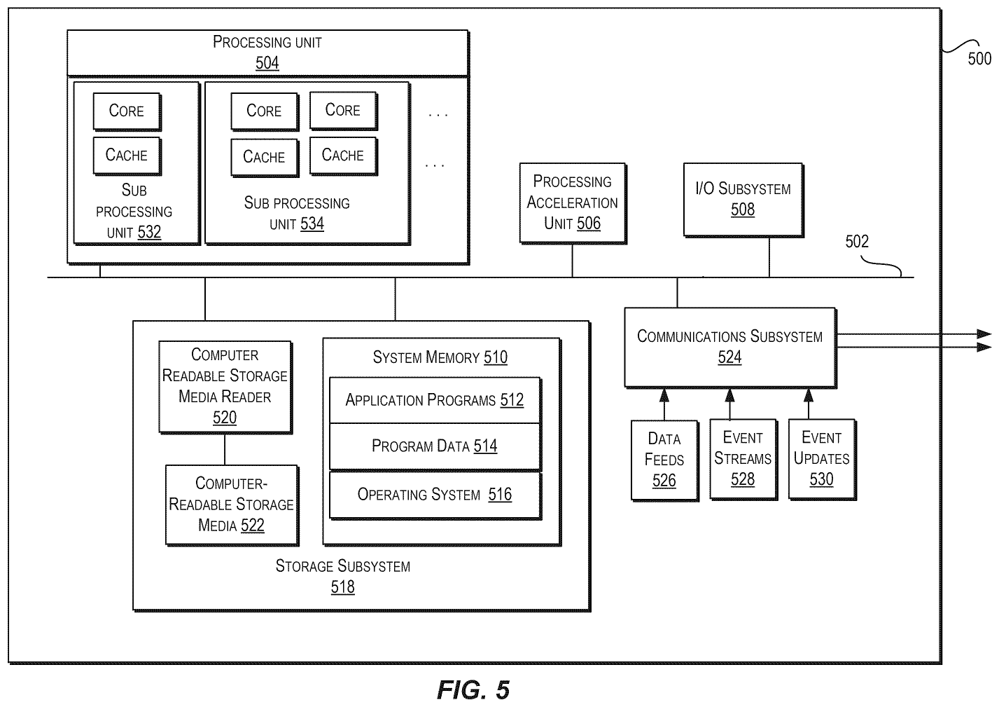

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may include a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. CLOUD PLATFORM ARCHITECTURE

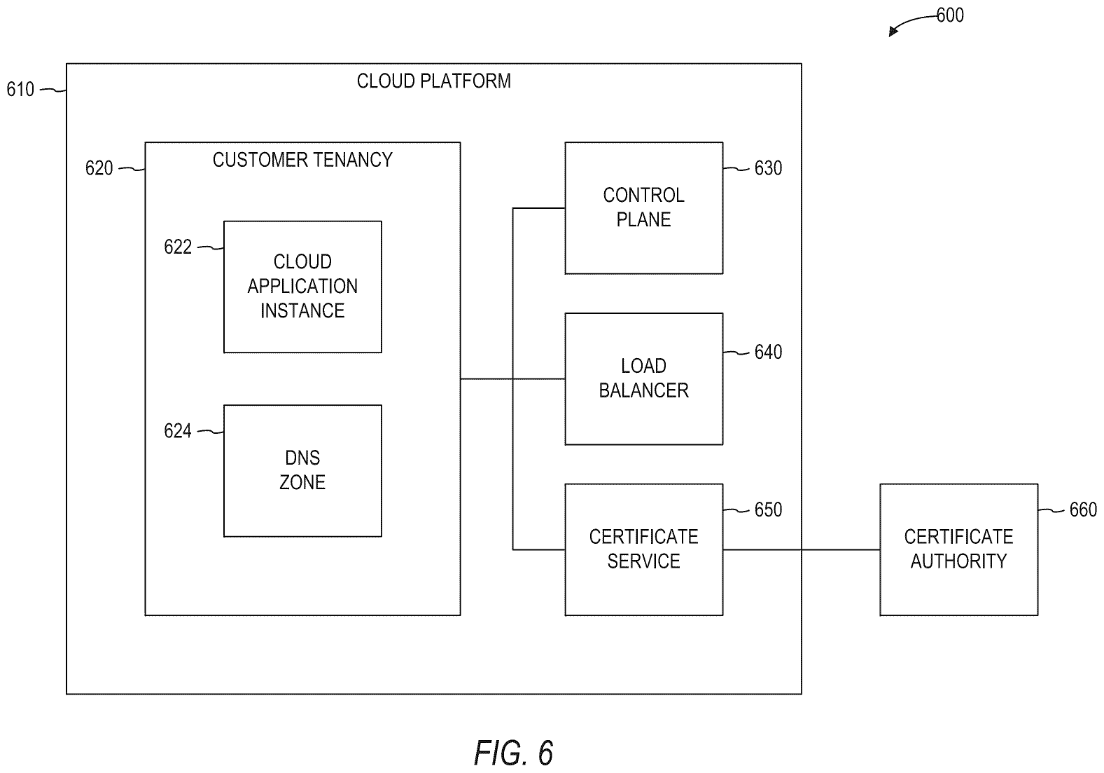

FIG. 6 illustrates a system 600 in which a cloud platform architecture is implemented in accordance with one or more embodiments. In some embodiments, the system 600 comprises a cloud platform 610 that includes a customer tenancy 620, a control plane 630, a load balancer 640, and a certificate service 650. In one or more embodiments, system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component. The components of the system 600 may communicate with one another via one or more computer networks. Furthermore, one or more components of the system 600 may be implemented as part of an IaaS architecture, such as one of the IaaS architectures 100, 200, 300, or 400 described above in Section 2, titled “CLOUD COMPUTING TECHNOLOGY.” Additionally, one or more components of the system 600 may be implemented as part of a computer system, such as the computer system 500 described in Section 3, titled “COMPUTER SYSTEM.”

In some embodiments, the cloud platform 610 comprises hardware, software, and an operating system within one or more data centers that are configured to provide cloud computing services to customers. The cloud platform 610 may create a virtual pool of shared resources to provide compute, data storage, and network services over the Internet. In an embodiment, the cloud platform 610 is configured to enable a user to deploy an instance of a cloud application, also referred to herein as a cloud application instance 622. The cloud application instance 622 may be deployed in a customer tenancy 620 of a tenant. The customer tenancy 620 includes a set of resources to which a tenant (e.g., a group of users) has access with specific privileges.

In one or more embodiments, the cloud application instance 622 is hosted in the customer tenancy 620, and the cloud application instance 622 is accessible via an original endpoint that is mapped to the cloud application instance 622. An endpoint is a label that maps to the cloud application instance 622 such that the endpoint can be used by a computing device or resource to access and interact with the cloud application instance 622. One example of an endpoint is a fully qualified domain name (FQDN). An FQDN is a complete domain name that specifies the exact location of a network resource on the Internet, including the hostname, domain name, and top-level domain (TLD), thereby providing a unique address for that specific resource within the Domain Name System (DNS). The DNS is a service that associates information with domain names. DNS servers may translate human-readable domain names into IP addresses needed for locating and identifying computer services and devices with the underlying network protocols.

In some embodiments, the customer tenancy 620 has a corresponding DNS zone 624. The DNS is broken up into different zones, distinctly managed areas in the DNS namespace. The DNS zone 624 is a specific portion of the DNS namespace that is managed by the tenant to which the customer tenancy 620 belongs. The DNS zone 624 functions as an administrative space allowing more granular control of the DNS components. The DNS zone 624 may split up authority over different segments of the DNS namespace—for instance, a domain and a subdomain—which gives administrators more precise control over DNS records, DNS name servers and other components.

In one or more embodiments, the control plane 630 is configured to create and distribute routing policies. In some embodiments, the control plane 630 is a network component that manages how data is sent, routed, and processed. The control plane 630 may be configured to perform a variety of functions, including, but not limited to, routing (e.g., creating and maintaining routing tables, determining the best path for network traffic), network topology (e.g., establishing and changing network topology), network configuration (e.g., managing network policies and routing protocols), system changes (e.g., adding, deleting, or modifying resources, and propagating those changes to the appropriate locations), and coordinating communication between different components. The control plane 630 may use various protocols to perform these functions, including routing protocols, network management protocols, and application layer protocols.

In some embodiments, the load balancer 640 is configured to provide automated traffic distribution from one entry point to multiple servers reachable via the cloud platform 610. The load balancer 640 may function as a public or private load balancer within the cloud platform 610. A public load balancer has a public IP address that is accessible from the Internet. A private load balancer has an IP address from the hosting subnet, which is visible only within the cloud platform 610. In some embodiments, the load balancer 640 is configured to create multiple listeners for an IP address to load balance traffic. Both public and private load balancers act as reverse proxies and can route data traffic to any backend server that is reachable from the cloud platform 610. A listener is a software component that waits for and responds to specific events or messages. The load balancer 640 may use listeners to check for incoming traffic on the IP address of the load balancer 640.

In one or more embodiments, the certificate service 650 is configured to obtain and manage digital certificates. A digital certificate is an electronic file that verifies the authenticity of a user, device, or server using cryptography and public key infrastructure (PKI). Digital certificates are also referred to as public key certificates or identity certificates. The certificate service 650 may be configured to obtain digital certificates from a certificate authority 660. The certificate authority 660 is an entity that stores, signs, and issues digital certificates. In some embodiments, the certificate authority 660 is external to the cloud platform 610 and managed by a separate entity. However, in other embodiments, the certificate authority 660 is implemented by the cloud platform 610.

In some embodiments, the digital certificates that are obtained and managed by the certificate service 650 include Secure Sockets Layer (SSL) or Transport Layer Security (TLS) certificates. An SSL/TLS certificate is a digital object that allows systems to verify the identity of an entity and subsequently establish an encrypted network connection to another system using the SSL/TLS protocol. Certificates are used within a PK, which provides a way for one party to establish the identity of another party using certificates if they both trust a third-party, such as the certificate authority 660. Other types of digital certificates are also within the scope of the present disclosure.

In an embodiment, the system 600 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. CREATING CUSTOM ENDPOINT FOR CLOUD APPLICATION INSTANCE

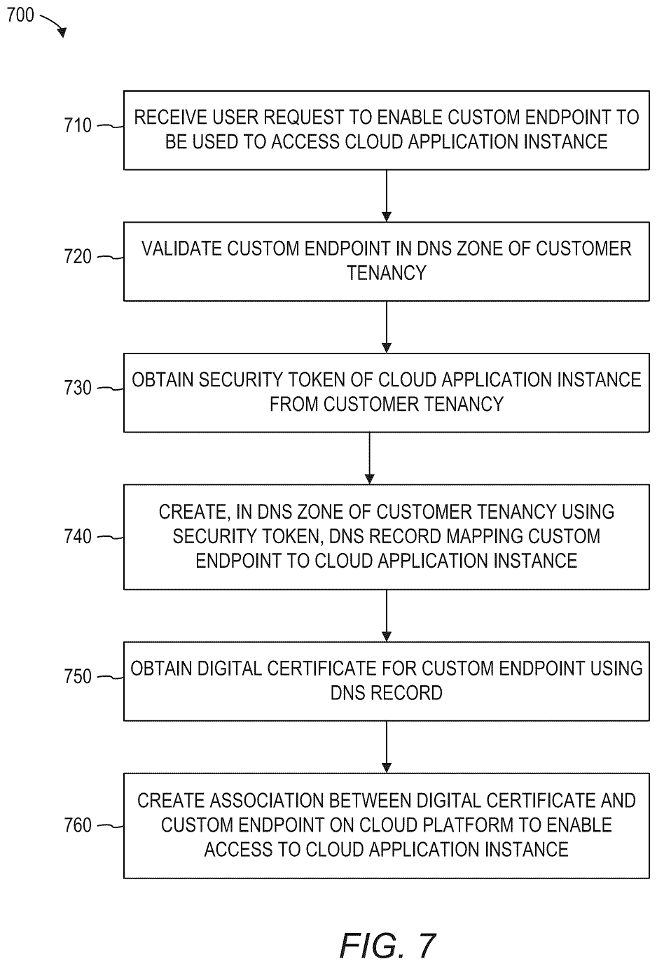

FIG. 7 illustrates an example set of operations 700 for creating a custom endpoint for a cloud application instance in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system 600 receives a user request to enable a custom endpoint to be used to access a cloud application instance 622 (Operation 710). The user request may specify the custom endpoint, such as by including the specific text or label of the custom endpoint. For example, a user may enter text, such as an FQDN, to be used for the custom endpoint in a text field displayed on a computing device of the user and then select a user interface element to submit the user request specifying the text to be used as the custom endpoint for the cloud application instance 622. The cloud application instance 622 may be hosted in a customer tenancy 620 of a cloud platform 610. In some embodiments, the cloud application instance 622 is accessible via an original endpoint that is mapped to the cloud application instance 622.

In one or more embodiments, the system 600, responsive to the user request, validates the custom endpoint in a DNS zone 624 of the customer tenancy 620 (Operation 720). For example, the system 600 may execute one or more operations to ensure that the custom endpoint can be used for the cloud application instance 622. For example, the system 600 may verify that the custom endpoint is not already in use by another resource. The system 600 may also verify that the custom endpoint satisfies one or more format rules.

In some embodiments, the system 600 obtains a security token of the cloud application instance 622 from the customer tenancy 620 (Operation 730). A security token is a software object that represents the right to perform some operation. Security tokens allow a client application to access protected resources on a resource server. The customer tenancy 620 may store and manage one or more security tokens. In an embodiment, the system 600 obtains the security token by transmitting a request for the security token to the customer tenancy 620. Other ways of obtaining the security token are also within the scope of the present disclosure.

In an embodiment, the system 600 creates a DNS record in the DNS zone 624 of the customer tenancy using the security token (Operation 740). The security token authorizes the creation of the DNS record in the DNS zone 624. The DNS zone 624 then stores the DNS record for subsequent use by the system 600. The DNS record maps the custom endpoint to the cloud application instance 622.

In one or more embodiments, the system 600 obtains a digital certificate for the custom endpoint using the DNS record (Operation 750). For example, the system 600 may invoke the certificate service 650 to request the issuance of the digital certificate from the certificate authority 660 using the DNS record. The DNS record functions as an authorization for the certificate authority 660 to issue the digital certificate for the custom endpoint. In some embodiments, the digital certificate comprises a TLS certificate. In one or more embodiments, the digital certificate comprises a domain validated certificate. A domain validated certificate is an X.509 public key certificate typically used for Transport Layer Security (TLS) where the domain name of the applicant is validated by proving some control over a DNS domain. The digital certificate may comprise other types of digital certificates as well.

In some embodiments, the system 600 creates an association between the digital certificate and the custom endpoint on the cloud platform 610 (Operation 760). The association between the digital certificate and the custom endpoint enables access to the cloud application instance 622 via the custom endpoint. For example, the system 600 may receive, from a computing device, a HyperText Transfer Protocol Secure (HTTPS) request comprising the custom endpoint, and then allow the computing device to access the cloud application instance 622 using the custom endpoint based on the association between the digital certificate and the custom endpoint. At the same time that the system 600 allow access to the cloud application instance 622 via the custom endpoint, the system 600 may also allow access to the cloud application instance 622 via the original endpoint. For example, the system 600 may receive, from a computing device, an HTTPS request comprising the original endpoint, and then allow the computing device to access the cloud application instance 622 using the custom endpoint based on the original endpoint being mapped to the cloud application instance 622.

In one or more embodiments, the system 600 creates the association between the first digital certificate and the custom endpoint by creating, in a load balancer 640 on the cloud platform 610, a listener for the custom endpoint, and then attaching the digital certificate to the listener. The load balancer 640 may include a corresponding listener for each endpoint associated with the cloud application instance 622. For example, the load balancer 640 may have a corresponding listener for the original endpoint to allow access to the cloud application instance 622 via the original endpoint, and the load balancer 640 may also have a corresponding listener for the custom endpoint to allow access to the cloud application instance 622 via the custom endpoint.

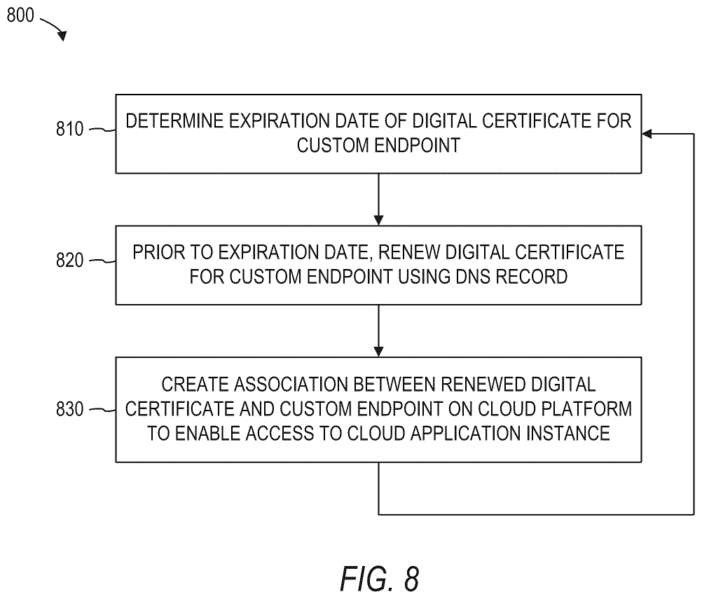

FIG. 8 illustrates an example set of operations 800 for renewing a digital certificate for a custom endpoint for a cloud application instance in accordance with one or more embodiments. One or more operations illustrated in FIG. 8 may be modified, rearranged, or omitted. Accordingly, the particular sequence of operations illustrated in FIG. 8 should not be construed as limiting the scope of one or more embodiments. The set of operations 800 may be incorporated into the set of operations 700 shown in FIG. 7. For example, the system 600 may execute the set of operations 800 subsequent to the system 600 creating the association between the digital certificate and the custom endpoint on the cloud platform 610 (Operation 760).

In an embodiment, the system 600 determines an expiration date of the digital certificate associated with the custom endpoint on the cloud platform 610 (Operation 810). The system 600 may extract the expiration date of the digital certificate from the digital certificate itself, such as in embodiments in which the expiration date is stored as part of the digital certificate. Alternatively, the system 600 may retrieve the expiration date of the digital certificate from another source, such as from a data repository (e.g., a database) that stores details of digital certificates being used by the cloud platform 610.

In one or more embodiments, the system 600, at a point in time prior to the expiration date of the digital certificate, automatically renews the digital certificate (Operation 820). The system 600 may configure the point in time to be a predefined amount of time (e.g., one week) prior to the expiration date of the digital certificate. In an embodiment, the system 600 renews the digital certificate by obtaining a new digital certificate for the custom endpoint using the DNS record. For example, the system 600 may invoke the certificate service 650 to request the issuance of the new digital certificate from the certificate authority 660 using the DNS record. The new digital certificate has an expiration date that is after the digital certificate that is currently associated with the custom endpoint on the cloud platform 610.

In some embodiments, the system 600 creates an association between the renewed digital certificate and the custom endpoint on the cloud platform 610 (Operation 830). The association between the renewed digital certificate and the custom endpoint enables access to the cloud application instance 610 via the custom endpoint. For example, in response to receiving an HTTPS request specifying the custom endpoint, the system 600 may use the renewed digital certificate to allow access to the custom endpoint instead of relying on the expired digital certificate. The system 600 may repeat the set of operations 800 periodically to ensure that the system 600 is not attempting to use an expired digital certificate to allow access to the cloud application instance 622 via the custom endpoint.

### 6. EXAMPLE EMBODIMENTS

Detailed examples are described below for purposes of clarity. Components and/or operations described below should be understood as one specific example that may not be applicable to certain embodiments. Accordingly, components and/or operations described below should not be construed as limiting the scope of any of the claims.

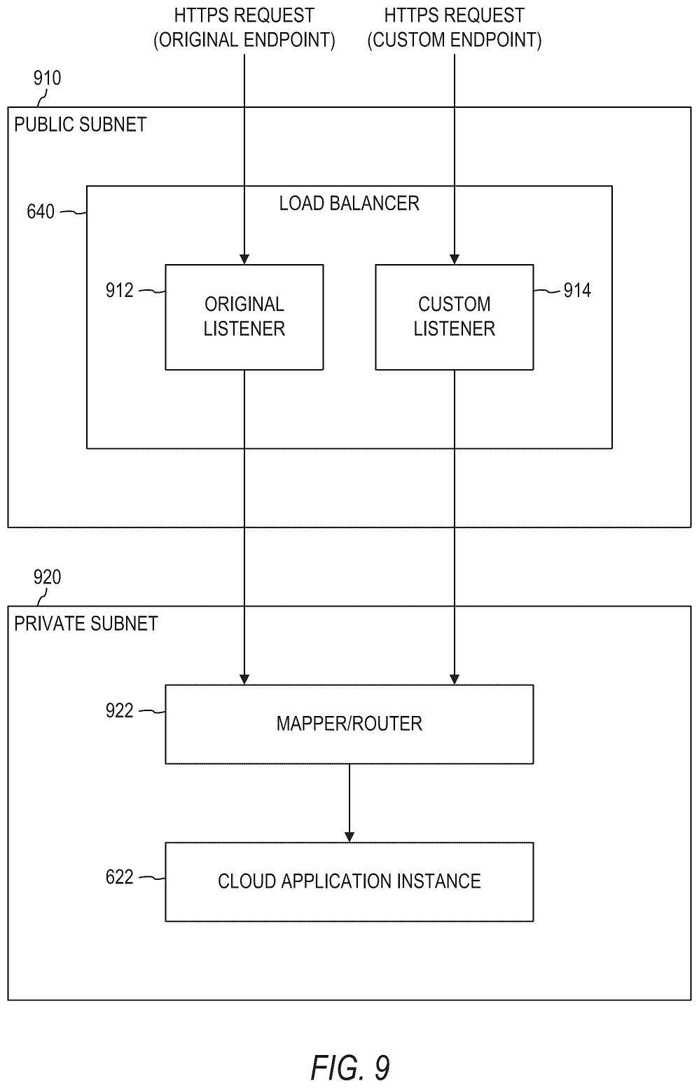

FIG. 9 illustrates an example embodiment of a cloud platform using a custom endpoint that has been created for a cloud application instance 622. In the example shown in FIG. 9, the cloud platform 610 includes a public subnet 910 and a private subnet 920. The public subnet 910 includes the load balancer 640. The private subnet 920 includes the cloud application instance 622. The load balancer 640 includes a corresponding listener for each endpoint associated with the cloud application instance 622. In this example, the load balancer 640 includes an original listener 912 for the original endpoint to allow access to the cloud application instance 622 via the original endpoint, and the load balancer 640 also includes a custom listener 914 for the custom endpoint to allow access to the cloud application instance 622 via the custom endpoint.

When the cloud platform 610 receives an HTTPS request comprising the original endpoint, the original listener 912 handles the HTTPS request. For example, the original listener 912 may confirm that a corresponding digital certificate for the original endpoint was issued. In response to confirming that a corresponding digital certificate for the original endpoint was issued, the original listener 912 may send the HTTPS request to a mapper/router component 922 of the private subnet 920. When the cloud platform receives an HTTPS request comprising the custom endpoint, the custom listener 922 handles the HTTPS request. For example, the custom listener 922 may confirm that a corresponding digital certificate for the custom endpoint was issued. In response to confirming that a corresponding digital certificate for the custom endpoint was issued, the custom listener 922 may send the HTTPS request to the mapper/router component 922 of the private subnet 920.

In some embodiments, the mapper/router component 922 of the private subnet 920 is configured to map HTTPS requests to corresponding resources, such as to cloud application instances, and then to route the HTTPS requests to those corresponding resources. In this example, the mapper/router component 922 maps both the HTTPS request that includes the original endpoint and the HTTPS request that includes the custom endpoint to the same cloud application instance 622. As a result, both the original endpoint and the custom endpoint may be used to access the cloud application instance 622.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media includes instructions which, when executed by one or more hardware processors, cause performance of any of the operations described herein and/or recited in any of the claims.

In an embodiment, a method includes operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method performed by at least one device including a hardware processor, the method comprising:
receiving a user request to enable a custom endpoint to be used to access a cloud application instance, the user request specifying the custom endpoint, wherein the cloud application instance is hosted in a customer tenancy of a cloud platform, wherein the cloud application instance is accessible via an original endpoint that is mapped to the cloud application instance; and
responsive to the user request:
validating the custom endpoint in a Domain Name System (DNS) zone of the customer tenancy;
obtaining a security token of the cloud application instance from the customer tenancy;
creating a DNS record in the DNS zone of the customer tenancy using the security token, the DNS record mapping the custom endpoint to the cloud application instance;
obtaining a first digital certificate for the custom endpoint using the DNS record; and
creating an association between the first digital certificate and the custom endpoint on the cloud platform, wherein the association between the first digital certificate and the custom endpoint enables access to the cloud application instance via the custom endpoint.

2. The method of claim 1, wherein the creating the association between the first digital certificate and the custom endpoint comprises:
creating, in a load balancer on the cloud platform, a listener for the custom endpoint; and
attaching the first digital certificate to the listener.

3. The method of claim 1, wherein the custom endpoint comprises a fully qualified domain name (FQDN).

4. The method of claim 1, wherein the first digital certificate comprises a Transport Layer Security (TLS) certificate.

5. The method of claim 1, further comprising:
receiving, from a first computing device, a first HyperText Transfer Protocol Secure (HTTPS) request comprising the custom endpoint; and
allowing the first computing device to access the cloud application instance using the custom endpoint based on the association between the first digital certificate and the custom endpoint.

6. The method of claim 5, further comprising:
receiving, from a second computing device, a second HTTPS request comprising the original endpoint; and
allowing the second computing device to access the cloud application instance using the custom endpoint based on the original endpoint being mapped to the cloud application instance.

7. The method of claim 1, further comprising:
determining a first expiration date of the first digital certificate; and
at a point in time prior to the first expiration date of the first digital certificate:
obtaining a second digital certificate for the custom endpoint using the DNS record, the second digital certificate having a second expiration date that is after the first digital certificate; and
creating an association between the second digital certificate and the custom endpoint on the cloud platform, wherein the association between the second digital certificate and the custom endpoint enables access to the cloud application instance via the custom endpoint.

8. One or more non-transitory computer readable media comprising instructions which, when executed by one or more hardware processors, cause performance of operations comprising:
receiving a user request to enable a custom endpoint to be used to access a cloud application instance, the user request specifying the custom endpoint, wherein the cloud application instance is hosted in a customer tenancy of a cloud platform, wherein the cloud application instance is accessible via an original endpoint that is mapped to the cloud application instance; and
responsive to the user request:
validating the custom endpoint in a Domain Name System (DNS) zone of the customer tenancy;
obtaining a security token of the cloud application instance from the customer tenancy;
creating a DNS record in the DNS zone of the customer tenancy using the security token, the DNS record mapping the custom endpoint to the cloud application instance;
obtaining a first digital certificate for the custom endpoint using the DNS record; and
creating an association between the first digital certificate and the custom endpoint on the cloud platform, wherein the association between the first digital certificate and the custom endpoint enables access to the cloud application instance via the custom endpoint.

9. The media of claim 8, wherein the creating the association between the first digital certificate and the custom endpoint comprises:
creating, in a load balancer on the cloud platform, a listener for the custom endpoint; and
attaching the first digital certificate to the listener.

10. The media of claim 8, wherein the custom endpoint comprises a fully qualified domain name (FQDN).

11. The media of claim 8, wherein the first digital certificate comprises a Transport Layer Security (TLS) certificate.

12. The media of claim 8, wherein the operations further comprise:
receiving, from a first computing device, a first HyperText Transfer Protocol Secure (HTTPS) request comprising the custom endpoint; and
allowing the first computing device to access the cloud application instance using the custom endpoint based on the association between the first digital certificate and the custom endpoint.

13. The media of claim 12, wherein the operations further comprise:
receiving, from a second computing device, a second HTTPS request comprising the original endpoint; and
allowing the second computing device to access the cloud application instance using the custom endpoint based on the original endpoint being mapped to the cloud application instance.

14. The media of claim 8, wherein the operations further comprise:
determining a first expiration date of the first digital certificate; and
at a point in time prior to the first expiration date of the first digital certificate:
obtaining a second digital certificate for the custom endpoint using the DNS record, the second digital certificate having a second expiration date that is after the first digital certificate; and
creating an association between the second digital certificate and the custom endpoint on the cloud platform, wherein the association between the second digital certificate and the custom endpoint enables access to the cloud application instance via the custom endpoint.

15. A system comprising:
at least one device including a hardware processor;
the system being configured to perform operations comprising:
receiving a user request to enable a custom endpoint to be used to access a cloud application instance, the user request specifying the custom endpoint, wherein the cloud application instance is hosted in a customer tenancy of a cloud platform, wherein the cloud application instance is accessible via an original endpoint that is mapped to the cloud application instance; and
responsive to the user request:
validating the custom endpoint in a Domain Name System (DNS) zone of the customer tenancy;
obtaining a security token of the cloud application instance from the customer tenancy;
creating a DNS record in the DNS zone of the customer tenancy using the security token, the DNS record mapping the custom endpoint to the cloud application instance;
obtaining a first digital certificate for the custom endpoint using the DNS record; and
creating an association between the first digital certificate and the custom endpoint on the cloud platform, wherein the association between the first digital certificate and the custom endpoint enables access to the cloud application instance via the custom endpoint.

16. The system of claim 15, wherein the creating the association between the first digital certificate and the custom endpoint comprises:
creating, in a load balancer on the cloud platform, a listener for the custom endpoint; and
attaching the first digital certificate to the listener.

17. The system of claim 15, wherein the custom endpoint comprises a fully qualified domain name (FQDN).

18. The system of claim 15, wherein the first digital certificate comprises a Transport Layer Security (TLS) certificate.

19. The system of claim 15, wherein the operations further comprise:
receiving, from a first computing device, a first HyperText Transfer Protocol (HTTP) request comprising the custom endpoint;
allowing the first computing device to access the cloud application instance using the custom endpoint based on the association between the first digital certificate and the custom endpoint;
receiving, from a second computing device, a second HTTP request comprising the original endpoint; and
allowing the second computing device to access the cloud application instance using the custom endpoint based on the original endpoint being mapped to the cloud application instance.

20. The system of claim 15, wherein the operations further comprise:
determining a first expiration date of the first digital certificate; and
at a point in time prior to the first expiration date of the first digital certificate:
obtaining a second digital certificate for the custom endpoint using the DNS record, the second digital certificate having a second expiration date that is after the first digital certificate; and
creating an association between the second digital certificate and the custom endpoint on the cloud platform, wherein the association between the second digital certificate and the custom endpoint enables access to the cloud application instance via the custom endpoint.
